(19) United States
(12) Patent Application Publication
(10) Pub. No.: US 2024/0328060 A1
(43) Pub. Date: Oct. 3, 2024

(54) CLOTHES HANGER CLIPS

(71) Applicant: Jenna Hally Rubenstein, New York, NY (US)

(72) Inventor: Jenna Hally Rubenstein, New York, NY (US)

(21) Appl. No.: 18/386,500

(22) Filed: Nov. 2, 2023

Related U.S. Application Data
(63) Continuation of application No. 17/774,429, filed on May 4, 2022, now abandoned.
(60) Provisional application No. 62/932,261, filed on Nov. 7, 2019.

(51) Int. Cl. D06F 55/02; A47G 25/48

(52) U.S. Cl. CPC D06F 55/02; A47G 25/485

(57) ABSTRACT

In accordance with various embodiments, clothes hanger clips are provided. In some embodiments, clips that can be attached to a clothes hanger are provided, the clips comprising: a first side having an outer surface and an inner surface, wherein a first portion of the inner surface of the first side is covered with a first material that includes at least one of a silicone gel, a thermoplastic elastomer, and a polyether; a second side having an outer surface and an inner surface, wherein a first portion of the inner surface of the second side is covered with a second material that includes at least one of a silicone gel, a thermoplastic elastomer, and a polyether; and a connector that couples an inner portion of the first side to an inner portion of the second side, wherein the clothes hanger is attached to the clip through the connector.

### CROSS REFERENCE TO RELATED APPLICATION

This application is a continuation of U.S. patent application Ser. No. 17/774,429, filed May 4, 2022, which is a national stage application under 35 U.S.C. § 371 of International Patent No. PCT/US2020/059517, filed Nov. 6, 2020, which claims the benefit of U.S. Provisional Patent Application No. 62/932,261, filed Nov. 7, 2019, each of which is hereby incorporated by reference herein in its entirety.

### TECHNICAL FIELD

The disclosed subject matter relates to clothes hanger clips.

### BACKGROUND

Clothes hangers are often used to hang garments, such as dresses, shirts, pants, skirts, etc. Clothes hangers often have clips that can be used to grip a garment to secure the garment to the hanger. However, in many cases, these clips can be of a size or material or design that damages the clothing gripped by the clip. For example, a clip that is used to hold a garment may leave damaging dents and/or ridge marks on the garment because the clip applies too much pressure to the garment, features a poor choice of material on a portion of the clip that touches the garment, and/or features poorly placed ridges on a portion of the clip that touches the garment.

Accordingly, it is desirable to provide new clips for clothes hangers

### SUMMARY

In accordance with various embodiments, clothes hanger clips are provided. In some embodiments, clips that can be attached to a clothes hanger are provided, the clips comprising: a first side having an outer surface and an inner surface, wherein a first portion of the inner surface of the first side is covered with a first material that includes at least one of a silicone gel, a thermoplastic elastomer, and a polyether; a second side having an outer surface and an inner surface, wherein a first portion of the inner surface of the second side is covered with a second material that includes at least one of a silicone gel, a thermoplastic elastomer, and a polyether; and a connector that couples an inner portion of the first side to an inner portion of the second side, wherein the clothes hanger is attached to the clip through the connector. In some of these embodiments, the clips further comprise a spring that causes the first material to press against the second material when nothing is in the clip. In some of these embodiments, the spring is a coil spring. In some of these embodiments, the connector causes the first material to press against the second material when nothing is in the clip. In some of these embodiments, the connector has a round hole through which a rod of the clothes hanger can pass. In some of these embodiments, the connector includes two opposing portions that can snap onto a rod of the clothes hanger. In some of these embodiments, the two opposing portions form a U-shaped opening. In some of these embodiments, the first material and the second material are identical materials. In some of these embodiments, the first material is a silicone gel. In some of these embodiments, the first material is a thermoplastic elastomer. In some of these embodiments, the first material is a polyether. In some of these embodiments, the first material is a silicone gel. In some of these embodiments, the first material is a thermoplastic elastomer. In some of these embodiments, the first material is a polyether. In some of these embodiments, the first material is covered with a Thermoplastic Polyurethane (TPU) Film. In some of these embodiments, the second material is covered with a Thermoplastic Polyurethane (TPU) Film. In some of these embodiments, the connector protrudes through the first side and the second side. In some of these embodiments, the clips the connector is bonded to the inner surface of the first side and the connector is bonded to the inner surface of the second side. In some of these embodiments, the first material has a Shore 00 Durometer between 10 and 20 inclusive. In some of these embodiments, the second material has a Shore 00 Durometer between 10 and 20 inclusive.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show illustrative examples of perspective views of clips that are detachable, and that can be attached to a hanger in accordance with some embodiments of the disclosed subject matter.

FIGS. 1C and 1D show illustrative examples of side views of clips that are detachable and that can be attached to a hanger in accordance with some embodiments of the disclosed subject matter.

FIG. 1E shows an illustrative example of a front view of a clip that is detachable and that can be attached to a hanger in accordance with some embodiments of the disclosed subject matter.

FIGS. 2A and 2B show illustrative examples of perspective views of clips that can be attached to a hanger in accordance with some embodiments of the disclosed subject matter.

FIGS. 2C and 2D show illustrative examples of side views of clips that can be attached to a hanger in accordance with some embodiments of the disclosed subject matter.

FIG. 2E shows an illustrative example of a front view of a clip that can be attached to a hanger in accordance with some embodiments of the disclosed subject matter.

FIG. 3 shows an illustrative example of clothes hanger clips attached to a hanger in accordance with some embodiments of the disclosed subject matter.

### DETAILED DESCRIPTION

In accordance with various embodiments, clothes hanger clips are provided.

In accordance with some embodiments of the disclosed subject matter, clips for clothes hangers are described. In some embodiments, a clip can include a left side and a right side, which can be joined or coupled in any suitable manner. In some embodiments, each of the left side and the right side of the clip can include a padding of any suitable dimensions. For example, in some embodiments, padding on the left side of the clip and the right side of the clip can have any suitable thickness (e.g., 0.1 inches thick, 0.2 inches thick, 0.3 inches thick, and/or any other suitable thickness). As another example, in some embodiments, padding on the left side of the clip and the right side of the clip can span any suitable inner portion of each side of the clip. In some embodiments, padding on the left side of the clip and padding on the right side of the clip can be made of any suitable material. For example, in some embodiments, the padding can be made of a silicone gel, a polyether, a thermoplastic elastomer, a viscoelastic gel polymer, viscoelastic polymers, a liquid silicone rubber, an elastomer, an elastomeric polymer, and/or any other suitable material. In some embodiments, the padding can have any suitable hardness, such as Shore 00 Durometer between 10 and 20, or any other suitable hardness. In some embodiments, to control the hardness of the padding, it can be heated at any suitable temperature for any suitable duration.

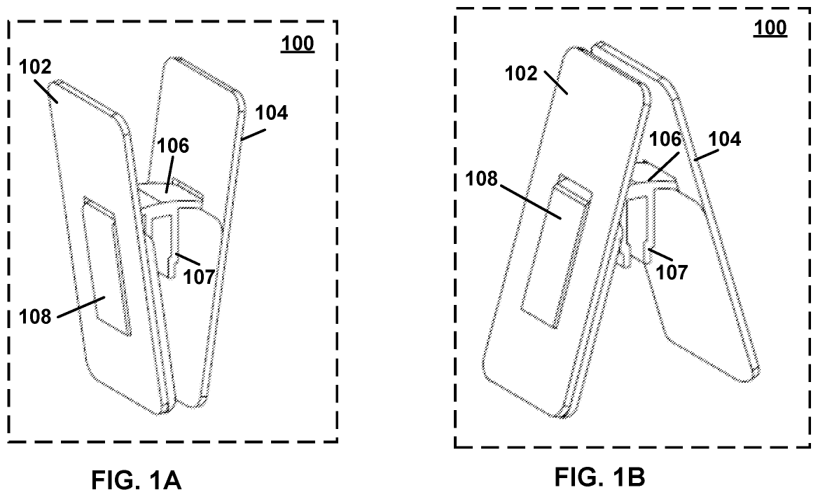

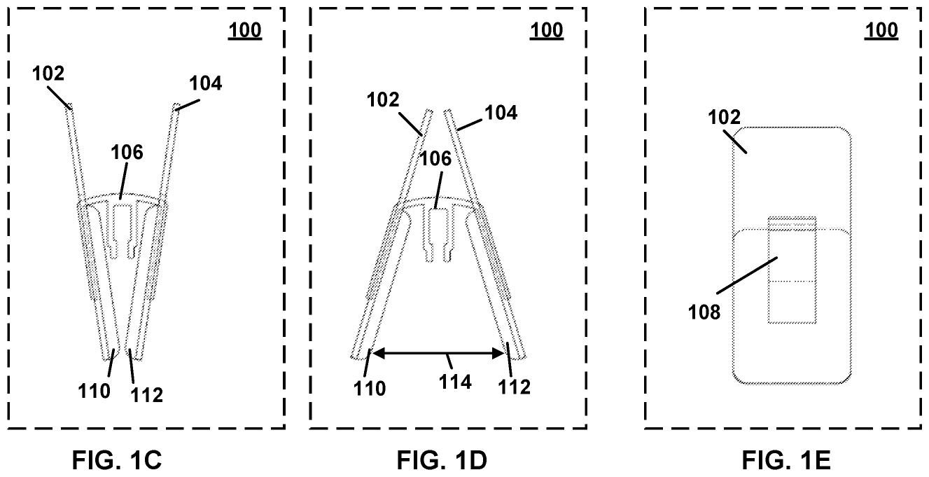

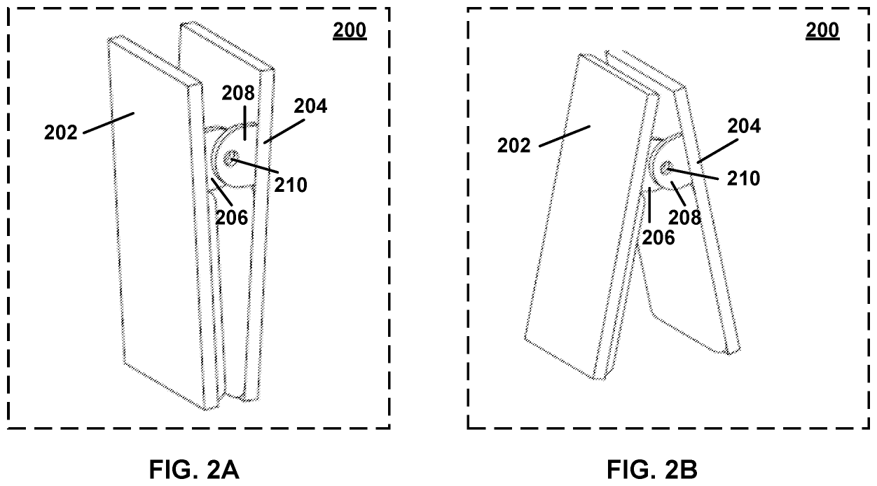

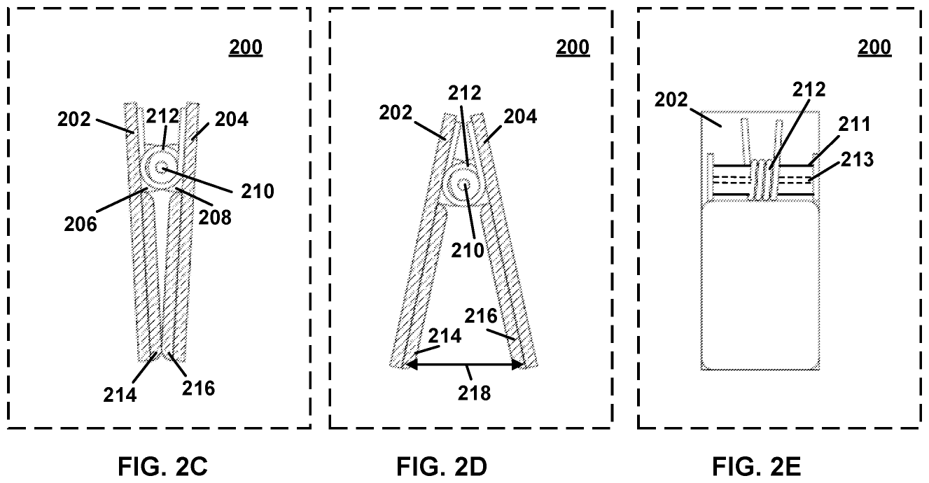

In some embodiments, a clip for a clothes hanger can include an interior slot such that the clip can be pressed onto a lower rod (or any other suitable portion) of a clothes hanger, as shown in and described below in connection with FIGS. 1A-1E. Additionally or alternatively, in some embodiments, a clip for a clothes hanger can include a connector that couples a left side of the clip with a right side of the clip, where the connector includes a hole such that a lower rod of a clothes hanger can be inserted through the hole of the connector, as shown in and described below in connection with FIGS. 2A-2E.

Turning to FIGS. 1A-1E, an example of a clip 100 that can be pressed onto a clothes hanger is shown in accordance with some embodiments of the disclosed subject matter.

FIGS. 1A and 1B show perspective views of clip 100 in a closed position and an open position, respectively. As illustrated in FIGS. 1A and 1B, clip 100 can include a left side 102, a right side 104, and a connector 106.

In some embodiments, left side 102 and right side 104 can be made of any suitable material (e.g., plastic, aluminum, acrylic, LUCITE, and/or any other suitable material). In some embodiments, left side 102 and/or right side 104 can be coated or covered with any suitable material. For example, in some embodiments, left side 102 and/or right side 104 can be coated or plated with any suitable material (e.g., chrome, silver, gold, and/or any other suitable material). As another example, in some embodiments, left side 102 and/or right side 104 can be covered with any suitable fabric (e.g., velvet, linen, cotton, and/or any other suitable fabric).

In some embodiments, connector 106 can be made of any suitable material (e.g., plastic, aluminum, acrylic, LUCITE, and/or any other suitable material). As shown in FIGS. 1A and 1B, connector 106 can have a hanging portion 107 that can be used to attach clip 100 to a hanger. As shown, hanging portion 107 can include two opposing portions that form a substantially U-shaped slot that can snap onto a rod or any other suitable portion of a hanger. For example, in some embodiments, clip 100 can be attached to a hanger via hanging portion 107 by inserting a bottom rod (or any other suitable portion) of the hanger through an opening of hanging portion 107. Note that, in some embodiments, the opening of hanging portion 107 can have any suitable dimension such that hangers with bottom rods (or any other suitable portions) of different diameters can be pushed through the opening of hanging portion 107. In some embodiments, as shown in FIGS. 1A and 1B, a portion 108 of connector 106 can be inserted through an opening of left side 102 to couple left side 102 to right side 104 via connector 106. Note that, although not shown in FIGS. 1A and 1B, a corresponding portion of connector 106 can be inserted through an opening of right side 104.

Turning to FIGS. 1C and 1D, side views of clip 100 are shown in accordance with some embodiments of the disclosed subject matter. As illustrated in FIGS. 1C and 1D, in some embodiments, clip 100 can include a left padding 110 and a right padding 112.

In some embodiments, left padding 110 can be attached to left side 102 and right padding 112 can be attached to right side 104. In some embodiments, left padding 110 and right padding 112 can be attached to left side 102 and right side 104 in any suitable manner (e.g., glue, and/or in any other suitable manner). In some embodiments, left padding 110 and right padding 112 can be made of any suitable material, such as a silicone gel, a polyether, a thermoplastic elastomer, a viscoelastic gel polymer, viscoelastic polymers, a liquid silicone rubber, an elastomer, an elastomeric polymer, and/or any other suitable material. In some embodiments, the padding can have any suitable hardness, such as Shore 00 Durometer between 10 and 20, or any other suitable hardness. Note that, in some embodiments, an inner portion of left padding 110 and/or right padding 112 can be made of any suitable material (as described above), and the inner portion can be covered with any suitable material (e.g., linen, cotton, velvet, a Thermoplastic Polyurethane (TPU) Film, and/or any other suitable material.

In some embodiments, left padding 110 and right padding 112 can each be of any suitable thickness (e.g., 0.05 inches, 0.1 inches, 0.15 inches, 0.2 inches, and/or any other suitable thickness). In some embodiments, left padding 110 and/or right padding 112 can span any suitable portion of the interior of left side 102 and/or right side 104 (e.g., 50% of the interior, 60% of the interior, 70% of the interior, and/or any other suitable portion), respectively.

As shown in FIG. 1D, in some embodiments, clip 100 can have an opening 114 of any suitable size (e.g., 1 inch, 1.5 inches, 2 inches, and/or any other suitable size) when clip 100 is in an open position. In some embodiments, a size of opening 114 can be determined based on any suitable factors, such as a vertical position of connector 106 along left side 102 and right side 104, a length of connector 106, and/or any other suitable factors.

Turning to FIG. 1E, a front view of clip 100 corresponding to left side 102 is shown in accordance with some embodiments of the disclosed subject matter. Note that, in some embodiments, clip 100 can have any suitable dimensions. For example, in some embodiments, a width of one side of clip 100 (e.g., left side 102, as shown in FIG. 1E) can be of any suitable size (e.g., 1 inch, 1.25 inches, 1.5 inches, 2 inches, and/or any other suitable size). As another example, in some embodiments, a height of one side of clip 100 (e.g., left side 102, as shown in FIG. 1E) can be of any suitable size (e.g., 1 inch, 1.25 inches, 1.5 inches, 2 inches, 2.5 inches, 2.75 inches, 3 inches, and/or any other suitable size).

Although FIGS. 1A-1E illustrate clip 100 as including a connector 106 the protrudes through sides 102 and 104 in accordance with some embodiments, in some embodiments connector 106 can be molded together with sides 102 and 104 to form a single piece, connector 106 can be glues or otherwise bonded to the inner sides of sides 102 and 104, and/or connector 106 can be integrate with sides 102 and 104 in any other suitable manner.

Turning to FIGS. 2A-2E, an example of a clip 200 in which a rod of a clothes hanger can be inserted is shown in accordance with some embodiments of the disclosed subject matter.

FIGS. 2A and 2B show perspective views of clip 200 in a closed position and an open position, respectively. As illustrated in FIGS. 2A and 2B, clip 200 can include a left side 202 and a right side 204.

In some embodiments, right side 202 and left side 204 can be made of any suitable material (e.g., plastic, aluminum, acrylic, LUCITE, and/or any other suitable material). Additionally, note that, in some embodiments, right side 202 and/or left side 204 can be coated or covered with any suitable material. For example, in some embodiments, left side 202 and/or right side 204 can be coated or plated with any suitable material (e.g., chrome, silver, gold, and/or any other suitable material). As another example, in some embodiments, left side 202 and/or right side 204 can be covered with any suitable fabric (e.g., velvet, linen, cotton, and/or any other suitable fabric.

In some embodiments, left side 202 can be connected to right side 204 in any suitable manner. For example, as shown in FIGS. 2A and 2B, left side 202 can have a left side connector 206, and right side 204 can have a right-side connector 208. In some embodiments, each of left side connector 206 and right-side connector 208 can have a hole 210. In some embodiments, left side connector 206 and right-side connector 208 can be aligned such that hole 210 of left side connector 206 overlaps with hole 210 of right-side connector 208. In some embodiments, a bottom wire or rod of a hanger (not shown) can be inserted through both holes 210 of left side connector 206 and right-side connector 208 such that clip 200 is attached to the hanger.

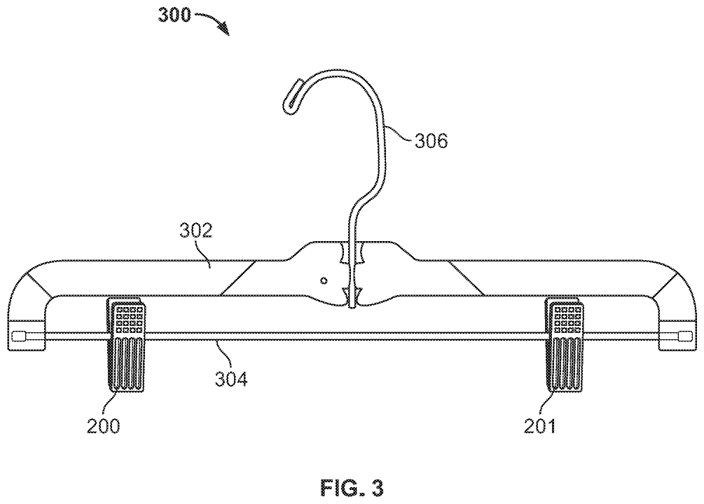

Turning to FIG. 3, an example of a hanger 300 on which a clip (e.g., clip 200, such as shown in and described above in connection with FIGS. 2A and 2B) is shown in accordance with some embodiments of the disclosed subject matter. As illustrated, in some embodiments, hanger 300 can include a base 302, a bottom rod 304, and a hook 306. Additionally, as shown in FIG. 3, in some embodiments, hanger 300 can have one or more clips (e.g., clip 200 and clip 201) through which bottom rod 304 is inserted, as described above in connection with FIGS. 2A and 2B.

In some embodiments, hanger 300 can be made of any suitable material or combination of materials. For example, in some embodiments, base 302 can be made of any suitable material, such as plastic, acrylic, LUCITE, wood, metal (e.g., steel, and/or any other suitable metal), fabric (e.g., cotton, linen, velvet, and/or any other suitable fabric), and/or any other suitable material. As another example, in some embodiments, bottom rod 304 can be made of any suitable material, such as plastic, acrylic, LUCITE, wood, metal (e.g., steel, aluminum, and/or any other suitable metal), fabric (e.g., cotton, linen, velvet, and/or any other suitable fabric), and/or any other suitable material. As yet another example, in some embodiments, hook 306 can be made of any suitable material, such as such as plastic, acrylic, LUCITE, wood, metal (e.g., steel, aluminum, and/or any other suitable metal), fabric (e.g., cotton, linen, velvet, and/or any other suitable fabric), and/or any other suitable material. Note that, in some embodiments, each of base 302, bottom rod 304, and/or hook 306 can be made of a different material.

Additionally, note that, in some embodiments, each of base 302, bottom rod 304, and/or hook 306 can be made of a first material and covered or plated with a second material. For example, in some embodiments, base 302 can be made of plastic, and covered in a fabric of any suitable type (e.g., linen, velvet, cotton, and/or any other suitable material). As another example, in some embodiments, hook 306 can be made with of steel, and can be gold-plated, chrome-plated, and/or plated with any other suitable material.

In some embodiments, clips 100 as illustrated in FIGS. 1A-1E can (additionally or alternatively to clips 200 and 201) be connected to rod 304 by snapping the clips onto the rod (for example).

Referring back to FIGS. 2C and 2D, side views of clip 200 are shown in accordance with some embodiments of the disclosed subject matter. As illustrated in FIGS. 2C and 2D, in some embodiments, clip 200 can include a left padding 214 and a right padding 216. In some embodiments, left padding 214 can be attached to left side 202 and right padding 216 can be attached to right side 204. In some embodiments, left padding 214 and right padding 216 can be attached to left side 202 and right side 204, respectively, in any suitable manner (e.g., glue, and/or in any other suitable manner). In some embodiments, left padding 214 and right padding 216 can be made of any suitable material, such as a silicone gel, a polyether, a thermoplastic elastomer, a viscoelastic gel polymer, viscoelastic polymers, a liquid silicone rubber, an elastomer, an elastomeric polymer, and/or any other suitable material. In some embodiments, the padding can have any suitable hardness, such as Shore 00 Durometer between 10 and 20 or any other suitable hardness. Note that, in some embodiments, an interior of left padding 214 and/or right padding 216 can be made of any suitable material (as described above), and can be covered with any suitable material (e.g., a fabric, such as cotton, linen, velvet, a Thermoplastic Polyurethane (TPU) Film, and/or any other suitable material).

Note that, similarly to what is described above in connection with FIGS. 1B and 1C, in some embodiments, left padding 214 and right padding 216 can each be of any suitable thickness (e.g., 0.05 inches, 0.1 inches, 0.15 inches, 0.2 inches, and/or any other suitable thickness). In some embodiments, left padding 214 and/or right padding 216 can span any suitable portion of the interior of left side 202 and/or right side 204 (e.g., 50%, 60%, 70%, and/or any other suitable portion), respectively.

As shown in FIG. 2D, in some embodiments, clip 200 can have an opening 218 of any suitable size (e.g., 1 inch, 1.5 inches, 2 inches, and/or any other suitable size) when clip 200 is in an open position. In some embodiments, a size of opening 218 can be determined based on any suitable factors, such as a vertical position of left side connector 206 along left side 202 and a vertical position of right side connector 208 along right side 204, and/or any other suitable factors.

As shown in FIGS. 2C and 2D, in some embodiments, clip 200 can include a spring 212 that can be used to push apart a top portion of left side 202 and a top portion of right side 204 to cause clip 200 to return to a closed portion (e.g., as shown in FIG. 2C). In some embodiments, spring 212 can be made of any suitable material (e.g., a metal, such as aluminum, steel, and/or any other suitable material) and can be any suitable shape (e.g., such as a coil, a bow, etc.).

Turning to FIG. 2E, a front view of clip 200 is shown in accordance with some embodiments of the disclosed subject matter. Note that, the front view of clip 200 shown in FIG. 2E can correspond to either left side 202 or right side 204. In some embodiments, clip 200 can have any suitable dimensions. For example, in some embodiments, a width of one side of clip 200 (e.g., left side 202, as shown in FIG. 2E) can be of any suitable size (e.g., 1 inch, 1.25 inches, 1.5 inches, 2 inches, and/or any other suitable size). As another example, in some embodiments, a height of one side of clip 200 (e.g., left side 202, as shown in FIG. 2E) can be of any suitable size (e.g., 1 inch, 1.25 inches, 1.5 inches, 2 inches, 2.5 inches, 2.75 inches, 3 inches, and/or any other suitable size).

As shown in FIG. 2E, spring 212 can be looped around a cylinder 211 in some embodiments. Note that, although spring 212 is shown as including three loops (e.g., three loops around cylinder 211), in some embodiments, spring 212 can be looped around cylinder 211 any suitable number of times (e.g., two, three, four, and/or any other suitable number). In some embodiments, cylinder 211 can have a hole 213 such that a bottom rod of a clothes hanger (e.g., bottom rod 304, such as shown in and described above in connection with FIG. 3) can be inserted through hole 213 of cylinder 211.

In some embodiments, rather than using a coil spring to cause clip 200 to close as shown in FIGS. 2C, 2D, and 2E, any other suitable type of spring can be used to cause clip 200 to close.

Accordingly, clothes hanger clips are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A clip that can be attached to a clothes hanger, comprising:
a first side having an outer surface and an inner surface, wherein a first portion of the inner surface of the first side is covered with a first material that includes at least one of a silicone gel, a thermoplastic elastomer, and a polyether;
a second side having an outer surface and an inner surface, wherein a first portion of the inner surface of the second side is covered with a second material that includes at least one of a silicone gel, a thermoplastic elastomer, and a polyether; and
a connector that couples an inner portion of the first side to an inner portion of the second side,
wherein the clothes hanger is attached to the clip through the connector.

2. The clip of claim 1, further comprising a spring that causes the first material to press against the second material when nothing is in the clip.

3. The clip of claim 2, wherein the spring is a coil spring.

4. The clip of claim 1, wherein the connector causes the first material to press against the second material when nothing is in the clip.

5. The clip of claim 1, wherein the connector has a round hole through which a rod of the clothes hanger can pass.

6. The clip of claim 1, wherein the connector includes two opposing portions that can snap onto a rod of the clothes hanger.

7. The clip of claim 1, wherein the two opposing portions form a U-shaped opening.

8. The clip of claim 1, wherein the first material and the second material are identical materials.

9. The clip of claim 1, wherein the first material is a silicone gel.

10. The clip of claim 1, wherein the first material is a thermoplastic elastomer.

11. The clip of claim 1, wherein the first material is a polyether.

12. The clip of claim 1, wherein the first material is a silicone gel.

13. The clip of claim 1, wherein the first material is a thermoplastic elastomer.

14. The clip of claim 1, wherein the first material is a polyether.

15. The clip of claim 1, wherein the first material is covered with a Thermoplastic Polyurethane (TPU) Film.

16. The clip of claim 1, wherein the second material is covered with a Thermoplastic Polyurethane (TPU) Film.

17. The clip of claim 1, wherein the connector protrudes through the first side and the second side.

18. The clip of claim 1, wherein the connector is bonded to the inner surface of the first side and the connector is bonded to the inner surface of the second side.

19. The clip of claim 1, wherein the first material has a Shore 00 Durometer between 10 and 20 inclusive.

20. The clip of claim 1, wherein the second material has a Shore 00 Durometer between 10 and 20 inclusive.
